(19) United States
(12) Patent Application Publication
(10) Pub. No.: US 2025/0363805 A1
(43) Pub. Date: Nov. 27, 2025

(54) SMART CART PREDICTION USING COMPUTER VISION

(71) Applicant: TOSHIBA GLOBAL COMMERCE SOLUTIONS, INC., Durham, NC (US)

(72) Inventors: Héctor G. RUELAS COBIÁN, Tlaquepaque (MX); David J. STEINER, Durham, NC (US); Martha E. CONTRERAS RAMIREZ, Zapopan (MX); Alejandra GONZÁLEZ GONZÁLEZ, Tlaquepaque (MX); Rafael LIZARDO SILVA, Villa de Álvarez (MX)

(21) Appl. No.: 18/674,656

(22) Filed: May 24, 2024

(51) Int. Cl. G06V 20/52; B62B 5/00; G06V 40/20

(52) U.S. Cl. CPC G06V 20/52; B62B 5/0076; G06V 40/20

(57) ABSTRACT

Techniques relating to machine learning (ML) in a shopping environment. The techniques include identifying one or more images captured in a shopping environment, and determining to automatically dispatch a cart to a shopper in the shopping environment. This includes predicting a use of the cart by the shopper based on providing the one or more images to one or more trained ML models. The techniques further include automatically dispatching the cart to the shopper. The cart automatically navigates in the shopping environment to the shopper.

### BACKGROUND

The present disclosure relates to machine learning (ML), including, to computer vision. Shoppers in retail stores, and other shopping environments, are often offered shopping carts and other storage implements to assist with shopping. Shoppers will sometimes, however, decline to take a shopping cart. For example, a shopper may expect to purchase a few items, and may prefer to carry the items in their hands. But the shopper may realize, while shopping, that they would like to purchase more items than they can easily carry by hand.

### BRIEF DESCRIPTION OF THE DRAWINGS

FIG. 1 illustrates an example shopping environment with smart cart prediction using computer vision, according to one embodiment.

FIG. 2 is a block diagram illustrating a controller for smart cart prediction using computer vision, according to one embodiment.

FIG. 3 is a flowchart illustrating smart cart prediction using computer vision, according to one embodiment.

FIG. 4 is a flowchart illustrating predicting a use of a smart cart, according to one embodiment.

FIG. 5 is a flowchart illustrating training an ML model for smart cart prediction using computer vision, according to one embodiment.

FIG. 6 is a flowchart illustrating inference using an ML model for smart cart prediction using computer vision, according to one embodiment.

### DETAILED DESCRIPTION

As discussed above, a shopper (e.g., in a retail environment) may realize, while shopping, that they would like to purchase more items than they can easily carry by hand. The lack of a shopping cart can become an inconvenience for the shopper, both frustrating the shopping experience and limiting the shopper's ability to purchase their desired items.

In an embodiment, this can be addressed through smart cart prediction using computer vision. Modern retail stores can include visual sensors (e.g., cameras or other image capture devices) capturing the state of the shopping environment. Further, smart shopping carts have been developed, which can travel within a retail environment automatically without human intervention. As discussed further below, in an embodiment an ML model (e.g., a computer vision ML model) can be trained to predict (e.g., based on a state of the shopping environment as captured using visual sensors) when a shopper does not have a shopping cart and might use a shopping cart. A smart cart can be automatically dispatched to the shopper, based on this prediction, and can navigate through the retail environment to reach the shopper's location. The shopper can then choose to use the smart shopping cart, to improve their shopping experience.

### Advantages of Smart Cart Prediction Using Computer Vision

As discussed above, in an embodiment ML (e.g., a computer vision ML model and one or more additional suitable ML model(s)) can be used to predict a shopper's use of a cart, and to dispatch a smart cart to a shopper. This has numerous technical advantages. For example, intelligent prediction of a use of a smart cart can reduce computational resources used by smart carts. In prior systems, a smart cart could be automatically dispatched to each shopper, whether or not the shopper is likely to use the cart. This wastes power and computational resources by providing shoppers with unused smart carts, in addition to harming the shopping experience. Using one or more ML models to predict usage of a smart cart allows for reduced, and targeted, deployment of smart carts when a use is predicted.

Further, as discussed below, in one embodiment the cart prediction can be implemented using a local controller located in a shopping environment, rather than at a remote controller (e.g., a remote cloud computing facility accessible over the Internet). This local control also has significant technical advantages, when it is used. For example, network transmission latency is significantly reduced between local sensors located in the shopping environment (e.g., cameras or other sensors) and the local controller, as compared to usage of a remote controller. As another example, local controller hardware and infrastructure can be tailored to implement cart prediction (e.g., using preferred or customized hardware and software infrastructure), potentially increasing the speed at which predictions occur while also reducing power and other overhead (e.g., by using specialized hardware for ML training and inference). This is another improvement over using a generalized remote controller (e.g., a multi-purpose cloud computing environment).

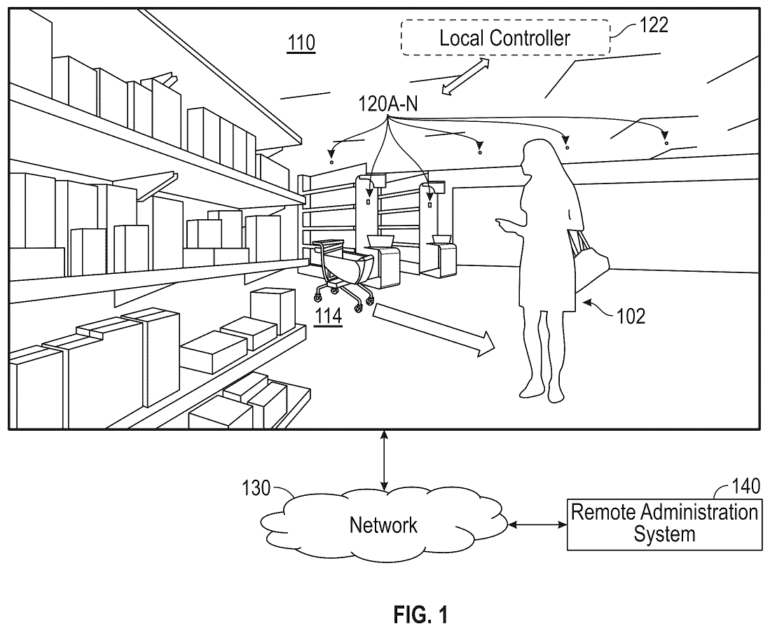

FIG. 1 illustrates an example shopping environment 110 with smart cart prediction using computer vision, according to one embodiment. In an embodiment, the shopping environment 110 relates to a store (e.g., a retail store). This is merely one example, and the shopping environment 110 can relate to any suitable environment or location.

A shopper 102 uses the shopping environment 110 to shop for items for purchase. In an embodiment, the shopping environment 110 includes a number of sensors 120A-N. For example, the sensors 120A-N can be cameras (e.g., visible spectrum cameras) or other image capture devices. This is merely an example, and any suitable sensors can be used (e.g., motion sensors, thermal sensors, sonic sensors, infrared sensors, or any other suitable sensors). In an embodiment, the sensors 120A-N can be used to identify the state of the shopping environment 110. Data from the sensors can be used to predict whether the shopper 102 is likely to use a shopping cart (e.g., a smart cart 114), and if so the smart cart 114 can be automatically dispatched to the shopper 102.

In one embodiment, the sensors 120A-N and smart cart 114 are controlled using a local controller 122. For example, the local controller 122 can be co-located with the sensors 120A-N in the shopping environment 110. The sensors 120A-N can communicate with the local controller 122 using a wired connection (e.g., an Ethernet connection, an optical connection, a USB connection, or any other suitable wired connection) or a wireless connection (e.g., an 802.11 connection or a cellular connection), and using a LAN or any other suitable communication network. Further, the smart cart 114 can communicate with the local controller 122 using a suitable wireless connection.

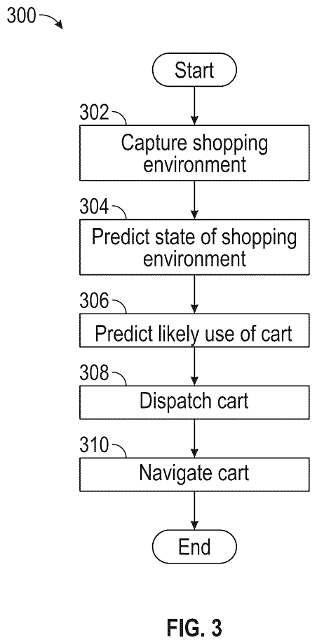

In an embodiment, the local controller 122 uses data from the sensors 120A-N to identify the state of the shopping environment 110, and to predict whether the shopper 102 is likely to use assistance from a smart cart (e.g., a smart cart 114). This is discussed further, below, with regard to FIG. 3. For example, the local controller 122 can use one or more ML models for this prediction. As one example, the local controller 122 can use a computer vision ML model to identify the state of the shopping environment (e.g., from visual sensor data), and a separate trained ML model to predict whether the shopper 102 is likely to use assistance from a smart cart. This is merely an example, and any suitable number or combination of ML models can be used. For example, a single ML model could be used, or more than two ML models could be used.

In an embodiment, as discussed above using the local controller 122 (e.g., as opposed to a remote administration system 140) to predict whether the shopper 102 is likely to use assistance from a smart cart has advantages. For example, because the local controller 122 is co-located with the sensors 120A-N and smart cart 114 in the shopping environment 110, network communication latency should be significantly reduced compared to communication with a remote administration system 140. Further, the local controller 122 can be implemented using specialized hardware and software designed for ML training and inference, potentially increasing the speed at which predictions occur while also reducing power and other overhead (e.g., compared with using more generalized computation infrastructure at a remote administration system 140).

Use of the local controller 122 is, however, merely one example. Alternatively, or in addition, the sensors 120A-N, smart cart 114, and other aspects of the shopping environment 110, can communicate with a remote administration system 140 using a network 130. The network 130 can be any suitable communication network, including a local area network (LAN), wide area network (WAN), cellular communication network, the Internet, or any other suitable communication network. The sensors 120A-N and smart cart 114 can communicate with the network 130 using any suitable network connection, including a wired connection (e.g., an Ethernet connection), a WiFi connection (e.g., an 802.11 connection), or a cellular connection.

In an embodiment, the sensors 120A-N and smart cart 114 can communicate with the remote administration system 140 to identify the state of the shopping environment 110, and to predict whether the shopper 102 is likely to use assistance from a smart cart (e.g., a smart cart 114). This is discussed further, below, with regard to FIG. 3. As above, for the local controller 122, the remote administration system 140 can use one or more ML models for this prediction. As one example, the remote administration system 140 can use a computer vision ML model to identify the state of the shopping environment (e.g., from visual sensor data), and a separate trained ML model to predict whether the shopper 102 is likely to use assistance from a smart cart. This is merely an example, and any suitable number or combination of ML models can be used. For example, a single ML model could be used, or more than two ML models could be used.

In another embodiment, this prediction can be divided between the local controller 122 and the remote administration system 140. For example, one of the local controller 122 or the remote administration system 140 can predict the state of the shopping environment 110 (e.g., using a suitable computer vision ML model, based on data from the sensors 120A-N), while the other of the local controller 122 or the remote administration system 140 can predict whether the shopper 102 is likely to use assistance from a smart cart (e.g., based on the state of the shopping environment predicted using the computer vision ML model).

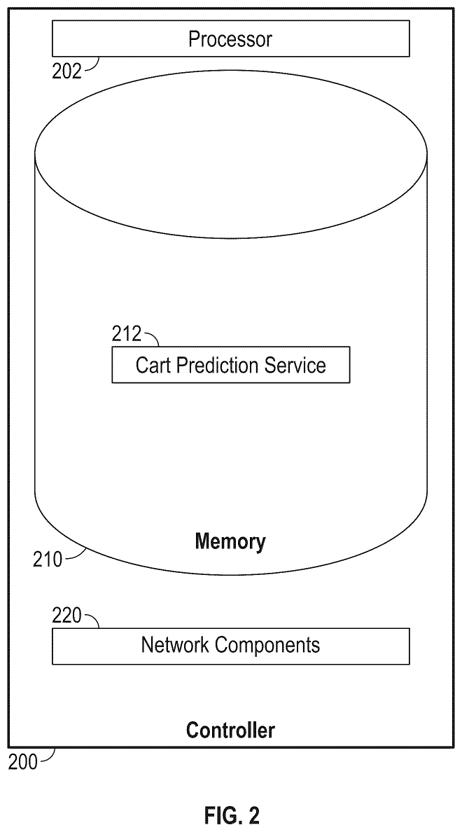

FIG. 2 is a block diagram illustrating a controller 200 for smart cart prediction using computer vision, according to one embodiment. In an embodiment, the controller 200 corresponds with the local controller 122 illustrated in FIG. 1, the remote administration system 140 illustrated in FIG. 1, or any suitable combination of control features spread across the local controller 122 and remote administration system 140.

The controller 200 includes a processor 202, a memory 210, and network components 220. The processor 202 generally retrieves and executes programming instructions stored in the memory 210. The processor 202 is representative of a single central processing unit (CPU), multiple CPUs, a single CPU having multiple processing cores, graphics processing units (GPUs) having multiple execution paths, and the like.

The network components 220 include the components for the controller 200 to interface with a suitable communication network (e.g., the communication network 130 illustrated in FIG. 1). For example, the network components 220 can include wired, WiFi, or cellular network interface components and associated software. Although the memory 210 is shown as a single entity, the memory 210 may include one or more memory devices having blocks of memory associated with physical addresses, such as random access memory (RAM), read-only memory (ROM), flash memory, or other types of volatile and/or non-volatile memory.

The memory 210 generally includes program code for performing various functions related to use of the controller 200. The program code is generally described as various functional “applications” or “modules” within the memory 210, although alternate implementations may have different functions and/or combinations of functions. Within the memory 210, the cart prediction service 212 facilitates smart cart prediction using computer vision. This is discussed further, below, with regard to FIGS. 3-6.

Although FIG. 2 depicts the cart prediction service 212 as located in the memory 210, that representation is merely provided as an illustration for clarity. More generally, the controller 200 may include one or more computing platforms, such as computer servers for example, which may be co-located, separated, or may form an interactively linked but distributed system, such as a cloud-based system (e.g., a public cloud, a private cloud, a hybrid cloud, or any other suitable cloud-based system). As a result, the processor 202 and memory 210 may correspond to distributed processor and memory resources within a computing environment. Further, in an embodiment the cart prediction service 212 may be divided across any suitable number of computing systems or compute nodes (e.g., in a cloud computing system), including fully or partially integrated within point of sale (POS) devices within a shopping environment (e.g., within the shopping environment 110 illustrated in FIG. 1), or divided between the local controller 122 and remote administration system 140 illustrated in FIG. 1.

FIG. 3 is a flowchart 300 illustrating smart cart prediction using computer vision, according to one embodiment. At block 302, a cart prediction service (e.g., the cart prediction service 212 illustrated in FIG. 2) captures a shopping environment. For example, the c cart prediction service (or any other suitable software service) can use one or more sensors (e.g., the sensors 120A-N illustrated in FIG. 1) to capture the shopping environment (e.g., the shopping environment 110 illustrated in FIG. 1). This can include the shopper (e.g., the shopper 102) and the surrounding shopping environment (e.g., aisles, shelves, other shoppers, employees, and any other suitable aspects of the shopping environment).

At block 304, the cart predication service predicts the state of the shopping environment. In an embodiment, the cart prediction service can use one or more ML models to predict the state of the shopping environment. For example, the cart prediction service can use a computer vision ML model to predict the state of the shopping environment by identifying characteristics of the shopper (e.g., posture, body language, movement characteristics, and any other suitable characteristics), identifying items surrounding or relating to the shopper (e.g., items being held by the shopper, nearby the shopper, or otherwise relating to the shopper), and identifying any other suitable aspects of the shopping environment.

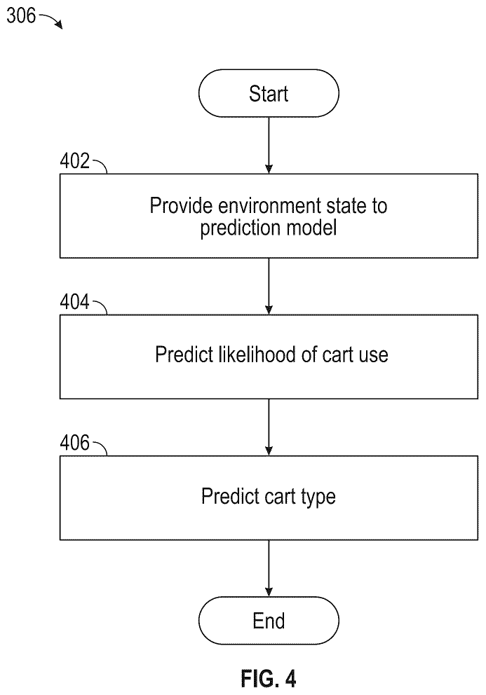

At block 306, the cart prediction service predicts the use of a cart. In an embodiment, the cart prediction service uses the predicted state of the shopping environment determined at block 304. For example, the cart prediction service can provide the identified characteristics of the shopper (e.g., posture, body language, movement characteristics, and any other suitable characteristics), identified items surrounding or relating to the shopper (e.g., items being held by the shopper, nearby the shopper, or otherwise relating to the shopper), and identifying any other suitable aspects of the shopping environment to an ML model trained to predict the use of a shopping cart. This is discussed further, below, with regard to FIG. 4.

At block 308, the cart prediction service dispatches the cart. In an embodiment, if the cart prediction service determines that a shopper is sufficiently likely to use a cart, the cart prediction service dispatches a cart. For example, at block 306 the cart prediction service can generate a numeric prediction score reflecting the likelihood that the shopper uses a cart (e.g., a confidence score). The cart prediction service can use this score (e.g., compare the score to a predefined threshold value) to determine whether to dispatch the cart. This is merely an example, and the cart prediction service can generate a boolean output at block 306 (e.g., a true or false output reflecting whether or not the shopper is likely to use a cart), or any other suitable output.

At block 310, the cart prediction service navigates the cart. In an embodiment, the smart cart self-navigates (e.g., using sensors located on the cart itself, sensors located in the shopping environment, or a combination of both) to the location of the shopper. For example, the cart prediction service can use visual sensors to identify the shopper's location in the retail environment, and can dispatch the cart to this location. As another example, the cart prediction service can identify an App voluntarily installed by a shopper (e.g., on their mobile phone, tablet, wearable device, or other computing device) and can use the App to identify the user's location (e.g., using the computing device) and dispatch the cart to that location.

As discussed above, in an embodiment a smart cart can us a variety of techniques to identify a shopper (e.g., when the shopper elects to enable this functionality). For example, a smart cart can include wireless communication functionality, including near field communication (NFC) functionality, to identify a user based on a wireless device carried by the user (e.g., a smartphone or wearable device running a suitable App). As another example, a smart cart can include one or more sensors (e.g., biometric sensors, image capture devices, or other suitable) and can identify a user based on captured characteristics of the user (e.g., facial recognition, fingerprint recognition, voice recognition, or any other suitable characteristic). In an embodiment, after the smart cart reaches the shopper, the smart cart can automatically remain nearby the shopper (e.g., trail behind the shopper), if desired.

Further, while the discussion above focuses on an automatically dispatched and navigating smart cart, this is merely an example. Alternatively, a human employee can be involved in dispatching the cart, navigating the cart, or both. For example, a human employee could receive an alert reflecting a predicted use of a cart for a shopper, and could choose to dispatch a cart and navigate the cart to the shopper. As another example, a human employee could dispatch the cart and the cart could automatically navigate to the shopper.

In an embodiment, the cart prediction service can further cancel dispatch of a smart cart. For example, the cart prediction service could identify that a shopper declines to use a dispatched smart cart (e.g., based on characteristics of the shopper), and could cancel the smart cart (e.g., command the smart cart to return to a centralized storage area). As one example, the cart prediction service could monitor whether the shopper uses the cart within a given time period (e.g., using computer vision), and could determine to cancel the smart cart if the period expires without the shopper using the cart. As another example, the cart prediction service can identify an action taken by the shopper (e.g., a gesture, voice command, or other action) to cancel the dispatch of the smart cart.

FIG. 4 is a flowchart illustrating predicting a use of a smart cart, according to one embodiment. In an embodiment, FIG. 4 corresponds with block 306 illustrated in FIG. 3. At block 402 a cart prediction service (e.g., the cart prediction service 212 illustrated in FIG. 2) provides the environmental state to a prediction model (e.g., a trained ML model). For example, as discussed above in relation to block 304 illustrated in FIG. 3, at block 402 the cart prediction service can use a suitable ML model (e.g., a computer vison ML model) to predict the environmental state of the shopping environment. In an embodiment, this predicted state information can include characteristics of the shopper (e.g., posture, body language, movement characteristics, and any other suitable characteristics), characteristics of identified items surrounding or relating to the shopper (e.g., items being held by the shopper, nearby the shopper, or otherwise relating to the shopper), and characteristics of any other suitable aspects of the shopping environment.

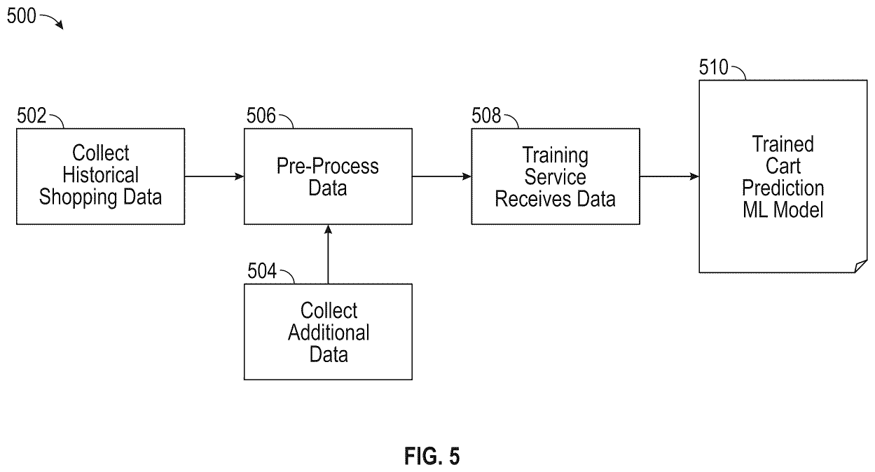

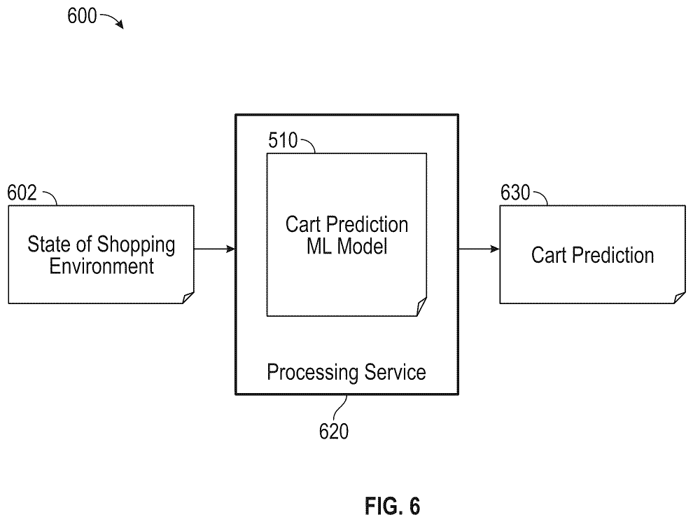

At block 404, the cart prediction service predicts a likelihood that a cart would be used. In an embodiment, the cart prediction service provides the predicted state information to a suitable ML model (e.g., a trained ML model) to predict the use of a cart based on this output. This is discussed further, below, with regard to FIGS. 5-6.

In an embodiment, the cart prediction service (e.g., a trained ML model used by the cart prediction service) can use a wide variety of factors to predict the use of a cart. These factors can include characteristics of items (e.g., items held by the shopper or nearby the shopper) and characteristics of the shopper (e.g., the shopper's posture or body language. For example, the item related factors can include the number of items held by the shopper (e.g., more items increases the likelihood the shopper uses a cart), the weight of the items being held (e.g., heavier items increase the likelihood the shopper uses a cart), and the volume or size of the item (e.g., larger items increase the likelihood the shopper uses a cart). The factors can further include other characteristics of the items, including an awkwardness factor for items being held by the shopper (e.g., items with a difficult to carry shape increase the likelihood the shopper uses a cart while items that are easily stacked decrease the likelihood that the shopper uses a cart), an expected temperature of the item (e.g., a cold item like a bag of ice, or a hot item like a prepared food item, can increase the likelihood the shopper uses a cart), a fragility of the item (e.g., fragile items increase the likelihood the shopper uses a cart).

In an embodiment, the shopper related characteristics can include the shopper's posture and body language (e.g., a shopper reflecting weariness can increase the likelihood the shopper uses a cart), the shopper's ability to hold additional items (e.g., identifying that the shopper is holding an item like a child or a bag, or that a shopper has limited carrying ability, can increase the likelihood the shopper uses a cart). The shopper related characteristics can further include a time that the shopper has been in the store (e.g., the longer the shopper has been in the store the more likely the shopper is to use a cart).

These are merely examples, and the cart prediction service can use any suitable factors or combinations of factors. For example, the factors can include store characteristics (e.g., a sale with reduced prices (e.g., a buy-one-get-one-free sale) can increase the likelihood the shopper uses a cart), global characteristics (e.g., an approaching holiday or approaching forecasted weather event can increase the likelihood the shopper uses a cart)

Further, in an embodiment, the cart prediction service can use both, or either, of characteristics relating to items actually being held by the shopper and characteristics of items nearby the shopper. For example, characteristics of items actually being held by the shopper can impact the prediction that the shopper is likely to use a cart. As another example, the cart prediction service can consider the shopper's posture and body language (among other factors), to identify items predicted to be of interest to the shopper in the future (e.g., the likelihood that a shopper wishes to pick up a nearby item). The shopper's gaze or other aspects of body posture can be used to predict items of future interest to the shopper and identify items the shopper wishes to purchase, and characteristics of these items can be used to predict the likelihood that the shopper uses a cart.

In an embodiment, the cart prediction service can use previously identified characteristics of the shopper to predict the use of a cart. For example, the cart prediction service can use historical preferences for the shopper (e.g., prior cart predictions, uses, or requests), historical shopping patterns for the shopper, and other suitable information.

Further, the cart prediction service (or another suitable software service) can present a user interface (e.g., in a mobile App) to allow the shopper to customize cart prediction. In an embodiment, the shopper can enable, or disable, the cart prediction feature. Further, in an embodiment the shopper can enable, or disable, the use of one or more factors in the cart prediction (e.g., historical data for the shopper, item characteristics, shopper posture or body language, or other suitable factors). The shopper can also, in an embodiment, customize the likelihood of a cart being predicted (e.g., using a slider or other suitable user interface). That is, in an embodiment the shopper can determine how frequently the cart prediction service should predict the use of a cart.

At block 406, the cart prediction service predicts cart type. In one embodiment, one type of smart cart is available, and the cart prediction service predicts a likelihood that a cart is used without addressing cart characteristics. Alternatively, multiple different types of smart cart are available and the cart prediction service predicts cart type. For example, smart carts of different sizes may be available (e.g., smaller carts and larger carts), or smart carts may be designed for different shopping experiences (e.g., carts may be designed to carry children or pets, flatbed carts may be designed to carry pallets or larger items, carts may be designed to assist the shopper with mobility, or carts may be designed for any other suitable shopping experience). In an embodiment, the cart prediction service predicts a preferred cart type, among the available cart types, for the shopper.

For example, the cart prediction service can use the environmental state data to predict the cart type. In one embodiment a cart prediction service can use a single ML model to predict both a likelihood a cart is used and a type of cart. Alternatively, or in addition, the cart prediction service can use multiple ML models. For example, one ML model could be trained to predict a likelihood a cart is used, and another could be trained to predict a cart type. These are merely examples.

FIG. 5 is a flowchart 500 illustrating training an ML model for smart cart prediction using computer vision, according to one embodiment. This is merely an example, and in an embodiment a suitable unsupervised technique could be used (e.g., without requiring training). At block 502, a training service (e.g., a human administrator or a software or hardware service) collects historical shopping data. For example, a cart prediction service (e.g., the cart prediction service 212 illustrated in FIG. 2) can be configured to act as a training service, and can collect historical data reflecting shopping environments. In an embodiment, the historical data includes predicted shopping environment data items and confidence score (e.g., output by a computer vision ML model, as discussed above in relation to FIG. 4), along with cart events corresponding to the predicted items and confidence score (e.g., instances where a shopper retrieved a cart, instances where lack of a cart impacted the shopping experience (e.g., the shopper dropped or returned items), and any other suitable information. This is merely an example, and any suitable historical shopping data can be used.

At block 506, the training service (or other suitable service) pre-processes the collected historical shopping data. For example, the training service can create feature vectors reflecting the values of various features, for historical shopping data. At block 508, the training service receives the feature vectors and uses them to train a trained cart prediction ML model 510.

In an embodiment, at block 504 the training service also collects additional data. For example, the training service can use shopper surveys, data reflecting purchase volumes, or any other suitable data to further refine cart predictions. At block 506, the training service can also pre-process this additional data. For example, the feature vectors corresponding to the historical shopping data can be further annotated using the additional data. Alternatively, or in addition, additional feature vectors corresponding to the additional data can be created. At block 508, the training service uses the pre-processed additional data during training to generate the trained cart prediction ML model 510.

In an embodiment, the pre-processing and training can be done as batch training. In this embodiment, the data is pre-processed at once (e.g., historical checkout data and additional data), and provided to the training service at block 508. Alternatively, the pre-processing and training can be done in a streaming manner. In this embodiment, the data is streaming, and is continuously pre-processed and provided to the training service. For example, it can be desirable to take a streaming approach for scalability. The set of training data may be very large, so it may be desirable to pre-process the data, and provide it to the training service, in a streaming manner (e.g., to avoid computation and storage limitations). Further, in an embodiment, a federated learning approach could be used in which multiple entities contribute to training a shared model.

FIG. 6 is a flowchart 600 illustrating inference using an ML model for smart cart prediction using computer vision, according to one embodiment. In an embodiment, a processing service 620 (e.g., the cart prediction service 212 illustrated in FIG. 2 or any other suitable software service) is associated with a cart prediction ML model 510. In an embodiment, the cart prediction ML model 510 is trained to infer a cart prediction 630 for the state of the shopping environment 602. For example, as discussed above in relation to block 404 illustrated in FIG. 4, the cart prediction ML model 510 can predict the likelihood that a cart is used based on the predicted state of the shopping environment 602 (e.g., including and confidence scores relating to the predicted state).

In an embodiment, the cart prediction 630 reflects a predicted use of a cart for the identified state of the shopping environment 602. Alternatively, or in addition, the cart prediction 630 identifies multiple suggested matches (e.g., a range of cart predictions). For example, the cart prediction 630 can identify a predicted type of cart for the shopper, as discussed above in relation to block 406 illustrated in FIG. 4.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to the described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the described embodiments may take the form of an entirely hardware embodiment, an entirely software embodiment (including firmware, resident software, micro-code, etc.) or an embodiment combining software and hardware aspects that may generally be referred to herein as a “circuit,” “module” or “system.”

One or more of the described embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the described embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the described embodiments.

Aspects of the described embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a described manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged for the computing resources actually used (e.g. an amount of storage space consumed by a user or a number of virtualized systems instantiated by the user). A user can access any of the resources that reside in the cloud at any time, and from anywhere across the Internet. In context of the described embodiments, a user may access applications (e.g., the cart prediction service 212 illustrated in FIG. 2) or related data available in the cloud. For example, the cart prediction service, or any aspect of the cart prediction service, could execute on a computing system in the cloud and predict a use of a cart. Further, suitable ML models, and associated data, could be stored at a storage location in the cloud. Doing so allows a user to access this information from any computing system attached to a network connected to the cloud (e.g., the Internet).

While the foregoing is directed to one or more embodiments, other and further embodiments may be devised without departing from the basic scope thereof, and the scope thereof is determined by the claims that follow.

What is claimed is:

1. A method comprising:
identifying one or more images captured in a shopping environment;
determining to automatically dispatch a cart to a shopper in the shopping environment, comprising:
predicting a use of the cart by the shopper based on providing the one or more images to one or more trained machine learning (ML) models; and
automatically dispatching the cart to the shopper, wherein the cart automatically navigates in the shopping environment to the shopper.

2. The method of claim 1, wherein the predicting the use of the cart by the shopper is determined using one or more computational systems located locally to the shopping environment.

3. The method of claim 2, wherein the one or more computational systems located locally to the shopping environment are accessible to devices in the shopping environment using at least one of a direct wired connection or a local area network (LAN) connection.

4. The method of claim 1, wherein predicting the use of the cart by the shopper based on providing the one or more images to one or more trained ML models comprises:
predicting a state of the shopping environment using the one or more images, based on providing the one more images to a first trained computer vision ML model, of the one or more trained ML models.

5. The method of claim 4, wherein predicting the use of the cart by the shopper based on providing the one or more images to one or more trained ML models further comprises:
providing data reflecting the state of the shopping environment to a second trained ML model, of the one or more trained ML models.

6. The method of claim 5, wherein the data reflecting the state of the shopping environment comprises at least one of: (i) data reflecting posture or body language for the shopper, (ii) data reflecting one or more items held by the shopper, or (iii) data reflecting one or more items predicted to be of interest to the shopper.

7. The method of claim 6, wherein the data reflecting the state of the shopping environment comprises the data reflecting posture or body language for the shopper.

8. The method of claim 6, wherein the data reflecting the state of the shopping environment comprises the data reflecting one or more items held by the shopper, comprising:
at least one of: (i) a size for an item held by the shopper, (ii) a shape for an item held by the shopper, (iii) a weight for an item held by the shopper, or (iv) a fragility for an item held by the shopper.

9. The method of claim 6, wherein the data reflecting the state of the shopping environment comprises the data reflecting one or more items predicted to be of interest to the shopper, comprising:
data reflecting items not currently held by the shopper and predicted to be of future interest to the shopper.

10. The method of claim 1, further comprising:
navigating the cart to the shopper, in the shopping environment without human intervention, based on or more sensors on the cart.

11. A non-transitory computer program product comprising:
one or more non-transitory computer readable media containing, in any combination, computer program code that, when executed by operation of any combination of one or more processors, performs operations comprising:
identifying one or more images captured in a shopping environment;
determining to automatically dispatch a cart to a shopper in the shopping environment, comprising:
predicting a use of the cart by the shopper based on providing the one or more images to one or more trained machine learning (ML) models; and
automatically dispatching the cart to the shopper, wherein the cart automatically navigates in the shopping environment to the shopper.

12. The non-transitory computer program product of claim 11, wherein the predicting the use of the cart by the shopper is determined using one or more computational systems located locally to the shopping environment, and wherein the one or more computational systems located locally to the shopping environment are accessible to devices in the shopping environment using at least one of a direct wired connection or a local area network (LAN) connection.

13. The non-transitory computer program product of claim 11, wherein predicting the use of the cart by the shopper based on providing the one or more images to one or more trained ML models comprises:
predicting a state of the shopping environment using the one or more images, based on providing the one more images to a first trained computer vision ML model, of the one or more trained ML models.

14. The non-transitory computer program product of claim 13, wherein predicting the use of the cart by the shopper based on providing the one or more images to one or more trained ML models further comprises:
providing data reflecting the state of the shopping environment to a second trained ML model, of the one or more trained ML models.

15. The non-transitory computer program product of claim 14, wherein the data reflecting the state of the shopping environment comprises at least one of: (i) data reflecting posture or body language for the shopper, (ii) data reflecting one or more items held by the shopper, or (iii) data reflecting one or more items predicted to be of interest to the shopper.

16. A system, comprising:
one or more processors; and
one or more memories storing a program, which, when executed on any combination of the one or more processors, performs operations, the operations comprising:
identifying one or more images captured in a shopping environment;
determining to automatically dispatch a cart to a shopper in the shopping environment, comprising:
predicting a use of the cart by the shopper based on providing the one or more images to one or more trained machine learning (ML) models; and
automatically dispatching the cart to the shopper, wherein the cart automatically navigates in the shopping environment to the shopper.

17. The system of claim 16, wherein the predicting the use of the cart by the shopper is determined using one or more computational systems located locally to the shopping environment, and wherein the one or more computational systems located locally to the shopping environment are accessible to devices in the shopping environment using at least one of a direct wired connection or a local area network (LAN) connection.

18. The system of claim 16, wherein predicting the use of the cart by the shopper based on providing the one or more images to one or more trained ML models comprises:
predicting a state of the shopping environment using the one or more images, based on providing the one more images to a first trained computer vision ML model, of the one or more trained ML models.

19. The system of claim 18, wherein predicting the use of the cart by the shopper based on providing the one or more images to one or more trained ML models further comprises:
providing data reflecting the state of the shopping environment to a second trained ML model, of the one or more trained ML models.

20. The system of claim 19, wherein the data reflecting the state of the shopping environment comprises at least one of: (i) data reflecting posture or body language for the shopper, (ii) data reflecting one or more items held by the shopper, or (iii) data reflecting one or more items predicted to be of interest to the shopper.
